(19) United States
(12) Patent Application Publication
(10) Pub. No.: US 2010/0265274 A1
(43) Pub. Date: Oct. 21, 2010

(54) OFFSET COMPENSATION GAMMA BUFFER AND GRAY SCALE VOLTAGE GENERATION CIRCUIT USING THE SAME

(75) Inventors: Dae-Keun Han, Daejeon-si (KR); Dae-Seong Kim, Daejeon-si (KR); Joon-Ho Na, Daejeon-si (KR); An-Young Kim, Daejeon-si (KR); Man-Jeong Ko, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICON WORKS CO., LTD, Daejeon-si (KR)

(21) Appl. No.: 12/741,924

(22) PCT Filed: Oct. 30, 2008
(86) PCT No.: PCT/KR08/06418

§ 371 Date: May 7, 2010

(30) Foreign Application Priority Data
Nov. 20, 2007 (KR) 10-2007-0118189

(51) Int. Cl. G09G 5/10; G09G 3/36

(52) U.S. Cl. 345/690; 345/89

(57) ABSTRACT

Disclosed are an offset compensation gamma buffer and a gray scale voltage generation circuit using the same. The offset compensation gamma buffer includes: a buffer which outputs an input voltage input to a positive or negative input terminal as an output voltage; and a switching unit which selectively connects the input voltage and the output voltage of the buffer to the positive and negative input terminals in response to a control signal. The output voltage of the offset compensation gamma buffer is supplied to the input of a gray scale voltage generation circuit of a source driver for driving a liquid crystal panel. The offset of the offset compensation gamma buffer is compensated using an inversion timing of the control signal. The output voltage of the offset compensation gamma buffer is supplied as a reference voltage of the voltage divider unit for generating the gray scale voltages, and the offset of the gray scale voltages is also compensated.

### BACKGROUND OF THE INVENTION

1. Field of the Invention

The present invention relates to a liquid crystal display device, and more particularly, to an offset compensation gamma buffer and a gray scale voltage generation circuit using the same.

2. Description of the Related Art

Generally, a liquid crystal display device includes a liquid crystal panel portion and a driving portion. The liquid crystal panel portion consists of: a bottom glass plate having pixel electrodes and thin-film transistors arranged in a matrix; a top glass plate having a common electrode and a color filter layer; and a liquid crystal layer interposed between the bottom and top glass plates. The driving portion consists of: an image signal processing unit which processes external image signals to output a composite synchronization signal; a control unit which receives the composite synchronization signal from the image signal processing unit, separately outputs horizontal and vertical synchronization signals, and controls a timing based on a mode selection signal; and gate and source drivers which sequentially apply driving voltages to gate and source lines of the liquid crystal panel portion in response to the output signal of the control unit.

The source driver samples digital red, green, and blue (RGB) data signals, latches the sampled digital RGB data in a data latch unit, decodes the digital RGB data stored in the data latch unit to convert the digital RGB data into analog RGB data in response to a gray scale voltage linearly representing intensity of light, and outputs output voltages corresponding to the converted analog RGB data to each channel. The output voltages of each channel are represented by, for example, 128 gray levels when the source driver has a unit of 6 bits. The gray scale voltages are generated using a gamma buffer which stabilizes a voltage generated through a voltage dividing unit.

FIG. 1 illustrates a conventional gamma buffer. Referring to FIG. 1, the buffer 10 receives an input voltage IN input to a positive input terminal (+) and its output voltage OUT fed back to a negative input terminal (−) to output a new feedback output voltage OUT. The gamma buffer 10 acts as a unit gain amplifier, of which the output voltage OUT has the same level as that of the input voltage IN without amplification.

FIGS. 2 and 3 are diagrams for describing offset voltages generated in the gamma buffer of FIG. 1. FIG. 2 shows gamma buffers 10a, 10b, and 10c arranged between chips or integrated into a single chip. FIG. 3 shows output voltage levels of the gamma buffers 10a, 10b, and 10c, in which first, second, and third output voltages OUT1, OUT2, and OUT3 of first, second, and third gamma buffers 10a, 10b, and 10c are (7+a) V, (7−b) V, and (7−c) V, respectively, when an input voltage level is set to 7V. The gamma buffers 10a, 10b, and 10c have intrinsic offset voltages a, b and c, respectively, and the offset voltages a, b and c are also included in the output voltages OUT1, OUT2, and OUT3, respectively.

FIG. 4 is a circuit diagram illustrating a gray scale voltage generation circuit for generating gray scale voltages using the gamma buffer shown in FIG. 1. Referring to FIG. 4, the gray scale voltage generation circuit 30 includes first to fourth gamma buffers 10a to 10d and first and second voltage dividers 31 and 32. The first voltage divider 31 is connected between output voltages OUT1 and OUT2 of the first and second gamma buffers 10a and 10b. The second voltage divider 32 is connected between the output voltages OUT3 and OUT4 of the third and fourth gamma buffers 10c and 10d. The first voltage divider 31 consists of a resistor string, and the voltage levels are divided by the resistor string to generate upper gray scale voltages VHgray0 to VHgray63. Similarly, the second voltage divider 32 consists of a resistor string, and the voltage levels are divided by the resistor string to generate lower gray scale voltages VLgray0 to VLgray63.

On the other hand, as the liquid crystal display devices are tending to be bigger, and the size of the liquid crystal panel portion increases, a plurality of source driver chips are connected in series to drive the liquid crystal panel portion. While the offset voltages of the gamma buffers integrated into a single source driver chip vary as shown in FIG. 2, the offset voltages of gamma buffers integrated into neighboring source driver chips also vary. That is, the gray scale voltages VHgray0 to VHgray63 and VLgray0 to VLgray63 generated from the gray scale voltage generation circuits 30 in each source driver chip are also generated with offset difference. This causes a block dim phenomenon which generates dark blocks in the image displayed by neighboring source driver chips.

### SUMMARY OF THE INVENTION

The present invention provides an offset compensation gamma buffer for removing a block dim phenomenon in an image.

Also, the present invention provides a gray scale voltage generation circuit using the offset compensation gamma buffer.

According to an aspect of the present invention, there is provided an offset compensation gamma buffer comprising: a buffer which outputs an input voltage input to a positive or negative input terminal as an output voltage; and a switching unit which selectively connects the input voltage and the output voltage of the buffer to the positive and negative input terminals in response to a control signal.

According to embodiments of the present invention, the output voltage of the offset compensation gamma buffer may be supplied as an input of the gray scale voltage generation circuit of a source driver for driving a liquid crystal panel.

According to embodiments of the present invention, the control signal may be set to be periodically inverted in the unit of one horizontal line and two frames of an image displayed in the liquid crystal panel.

According to embodiments of the present invention, the control signal may be set to be periodically inverted in the unit of one horizontal line and four frames of an image displayed in the liquid crystal panel.

According to embodiments of the present invention, the control signal may be set to be periodically inverted in the unit of two horizontal lines and two frames of an image displayed in the liquid crystal panel.

According to embodiments of the present invention, the control signal may be set to be periodically inverted in the unit of two horizontal lines and four frames of an image displayed in the liquid crystal panel.

According to embodiments of the present invention, the control signal may be set to be periodically inverted in the unit of four horizontal lines and two frames of an image displayed in the liquid crystal panel.

According to embodiments of the present invention, the control signal may be set to be periodically inverted in the unit of four horizontal lines and four frames of an image displayed in the liquid crystal panel.

According to embodiments of the present invention, the control signal may be set to be periodically inverted in the unit of two frames of an image displayed in the liquid crystal panel.

According to embodiments of the present invention, the control signal may be set to be periodically inverted in the unit of four frames of an image displayed in the liquid crystal panel.

According to another aspect of the present invention, there is provided a gray scale voltage generation circuit comprising: a buffer unit which receives first and second input voltages and outputs first and second output voltages; and a gray scale voltage generation unit which includes a resistor string connected between the first and second output voltages and generates gray scale voltages divided by the resistor string, wherein the buffer unit has: a first buffer which outputs the first input voltage input to a first positive input terminal or a first negative input terminal as the first output voltage; a second buffer which outputs the second input voltage input to a second positive input terminal or a second negative input terminal as the second output voltage; a first switching unit which selectively connects the first input voltage and the first output voltage of the first buffer to the first positive input terminal and the first negative input terminal in response to a control signal; and a second switching unit which selectively connects the second input voltage and the second output voltage of the second buffer to the second positive input terminal and the second negative input terminal in response to the control signal.

According to embodiments of the present invention, the gray scale voltage generation circuit may further comprise a third buffer unit which generates at least one third output voltage having a voltage level between the first and second output voltages, and connects the third output voltage to at least one connecting node arranged in the resistor string. The third buffer unit may have: a third buffer which outputs a third input voltage input to a third positive input terminal or a third negative input terminal as the third output voltage; and a third switching unit which selectively connects the third input voltage and the third output voltage of the third buffer to the third positive input terminal and the third negative input terminal in response to the control signal.

According to embodiments of the present invention, the buffer unit may selectively disable the first or second buffer in response to an option signal.

According to the present invention, the offset of the offset compensation gamma buffer is compensated using an inversion timing of a control signal. Since the output voltage of the offset compensation gamma buffer is supplied as a reference voltage to the voltage divider for generating gray scale voltages, the gray scale voltages having the compensated offset are generated. Accordingly, it is possible to remove a block dim phenomenon in the image displayed by neighboring source driver chips.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional gamma buffer;

FIGS. 2 and 3 are diagrams for describing an offset voltage of the gamma buffer of FIG. 1;

FIG. 4 illustrates a gray scale voltage generation circuit using the gamma buffer of FIG. 1;

FIG. 5 illustrates an offset compensation gamma buffer according to an embodiment of the present invention;

FIG. 6 is a plot for describing an offset compensation method using the offset compensation gamma buffer 40 of FIG. 5;

FIG. 7 is a timing chart for applying the offset compensation method of FIG. 6 to a horizontal two-dot inversion driving method of a liquid crystal display device;

FIG. 8 is a table for describing inversion timings of the control signal of the offset compensation gamma buffer of FIG. 5; and

FIG. 9 illustrates a gray scale voltage generation circuit using the offset compensation gamma buffer of FIG. 5.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

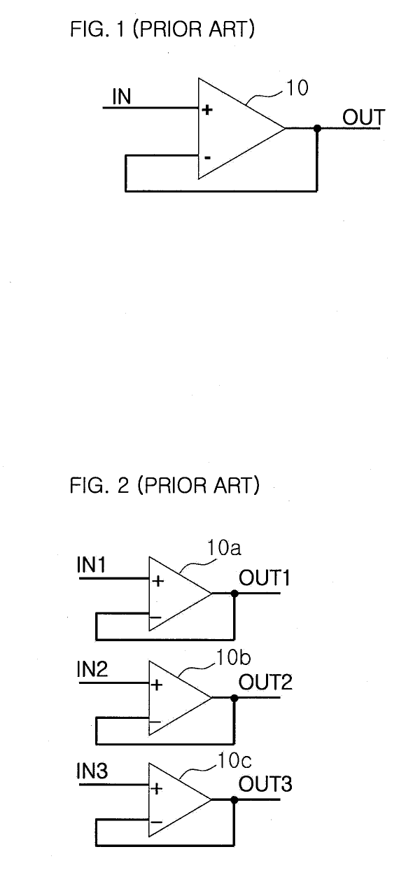

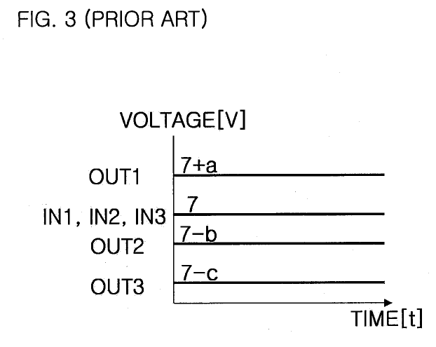

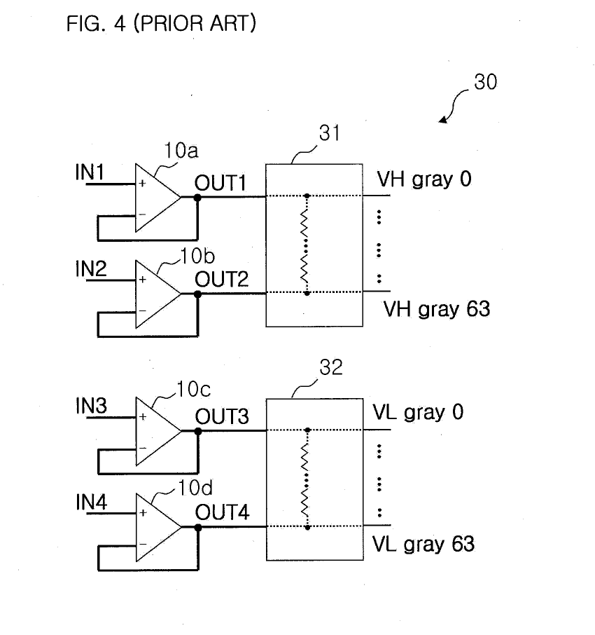

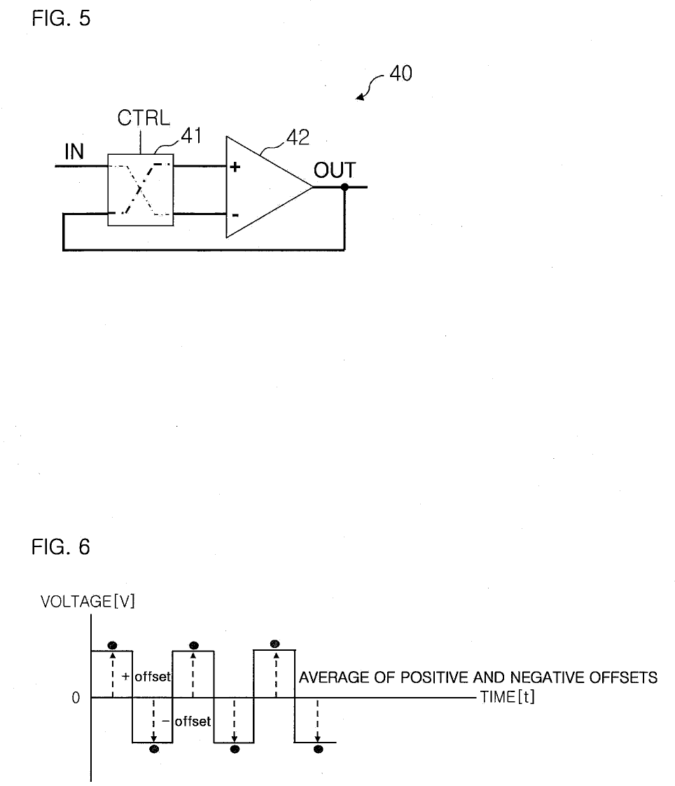

FIG. 5 illustrates an offset compensation gamma buffer according to an embodiment of the present invention. Referring to FIG. 5, the offset compensation gamma buffer 40 includes a switching unit 41 and a buffer 42. The switching unit 41 selectively connects an input voltage IN and an output voltage OUT of a buffer 42 to a positive or negative input terminal of the buffer 42 in response to a control signal CTRL. For example, when the control signal CTRL is logically high, the input voltage IN is input to the positive input terminal of the buffer 42, and its output voltage OUT is fed back to the negative input terminal as shown in FIG. 1, so that the output voltage OUT finally has a positive (+) offset. On the other hand, when the control signal CTRL is logically low, the input voltage IN is input to the negative input terminal of the buffer 42, and its output voltage OUT is fed back to the positive input terminal, so that the output voltage OUT of the buffer 42 finally has a negative (−) offset.

FIG. 6 is a plot for describing an offset compensation method using the offset compensation gamma buffer 40 of FIG. 5. Referring to FIG. 6, when the input voltage IN and the output voltage OUT of the buffer 42 input to the positive input terminal and the negative input terminal of the buffer 42 are alternately switched, the positive and negative offset voltages are averaged, and a total offset becomes zero. Therefore, the intrinsic offset generated in a conventional gamma buffer (10 of FIG. 1) is compensated.

On the other hand, the liquid crystal display device is required to invert the voltage applied to the pixel. This operation is performed to prevent display degradation such as image persistence that can be generated by parasitic charges caused by impurities or degradation of a liquid crystal material or an alignment film when an electric field having a single polarity is applied for a long period of time.

In order to prevent degradation of the pixels, polarities of voltages applied to each pixel should be inverted in every frame. In this case, a flicker may be generated in the liquid crystal panel due to a small brightness difference between both polarities. Various driving methods such as a line inversion driving, a column inversion driving, and a dot inversion driving have been proposed to alleviate the flicker. In the line inversion driving, the liquid crystal display is driven by inverted polarities of voltages applied to adjacent gate lines. In the column inversion driving, the liquid crystal display is driven by inverted polarities of voltages applied to adjacent data lines. In the dot inversion driving, the aforementioned two driving methods are combined such that the liquid crystal display is driven by inverted polarities of voltages applied to adjacent dots with respect to each other.

These driving methods are to reduce an average brightness difference between each dot in a certain area based on a fact that human eyes simultaneously perceive a plurality of dots. Generally, the dot inversion driving is known as the most effective method to remove inconvenience of users and most widely used as an inversion driving method of a liquid crystal display device.

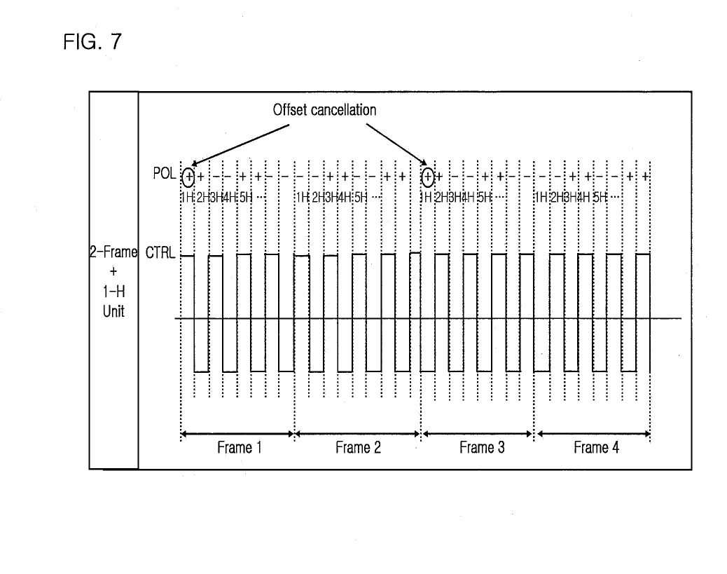

FIG. 7 is a timing chart for applying the offset compensation method of FIG. 6 to a horizontal two-dot inversion driving method of a liquid crystal display device. Referring to FIG. 7, the logic level of the control signal CTRL of the offset compensation gamma buffer 40 is periodically inverted in the unit of two frames, i.e., at first and third frames Frame1 and Frame3 and at second and fourth frames Frame2 and Frame4. Accordingly, the offset values of the offset compensation gamma buffer 40 are averaged and compensated in the unit of two frames.

In addition, the logic level of the control signal CTRL is periodically inverted in the unit of one horizontal line H even in a frame. This shows that the offset values of the offset compensation gamma buffer 40 are averaged and compensated when the voltages applied to the horizontal lines have polarities in the order of positive-positive or negative-negative polarities.

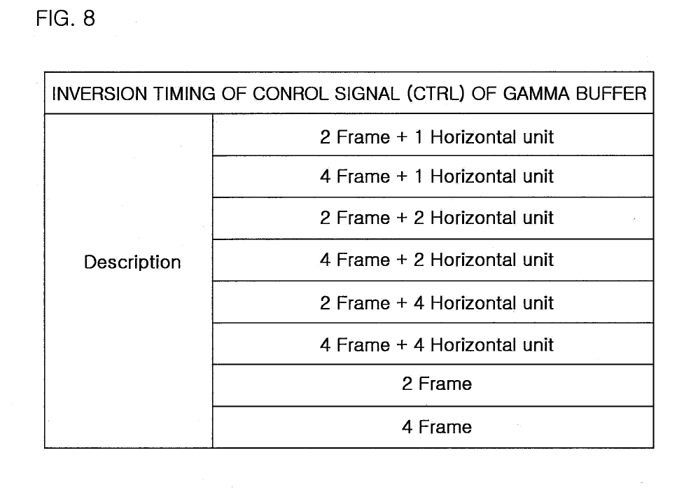

That is, as shown in FIG. 7, the offset values of the offset compensation gamma buffer 40 are compensated by periodically inverting the control signal CTRL of the offset compensation gamma buffer 40 in the unit of one horizontal line and two frames in addition to a horizontal two-dot inversion driving method. Similarly, the offset values of the offset compensation gamma buffer 40 of FIG. 8 can be also compensated by using inversion timings of the control signal CTRL of the offset compensation gamma buffer 40.

The inversion timing of the control signal CTRL of the offset compensation gamma buffer of FIG. 8 may be appropriately applied based on various driving methods such as horizontal inversion, column inversion, dot inversion, and square inversion driving methods of the liquid crystal display device. Specifically, as described above in relation to FIG. 7, the control signal CTRL of the offset compensation gamma buffer 40 may be periodically inverted in the unit of one horizontal line and two frames (2 Frame+1 Horizontal unit). Alternatively, it may be periodically inverted in the unit of one horizontal line and four frames (4 Frame+1 Horizontal unit). Alternatively, it may be periodically inverted in the unit of two horizontal lines and two frames (2 Frame+2 Horizontal unit). Alternatively, it may be periodically inverted in the unit of two horizontal lines and four frames (4 Frame+2 Horizontal unit). Alternatively, it may be periodically inverted in the unit of four horizontal lines and two frames (2 Frame+4 Horizontal unit). Alternatively, it may be periodically inverted in the unit of four horizontal lines and four frames (4 Frame+4 Horizontal unit). Alternatively, it may be periodically inverted in the unit of two frames (2 Frame unit). Alternatively, it may be periodically inverted in the unit of four frames (4 Frame unit).

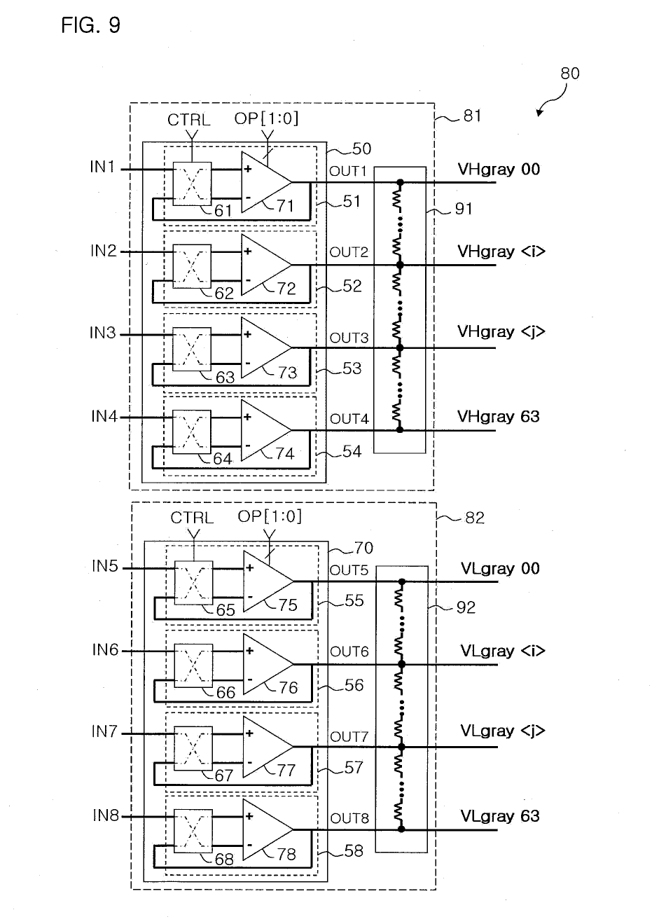

FIG. 9 illustrates a gray scale voltage generation circuit using the offset compensation gamma buffer 40 of FIG. 5. Referring to FIG. 9, the gray scale voltage generation circuit 80 includes an upper gray scale voltage generation portion 81 and a lower gray scale voltage generation portion 82. The upper gray scale voltage generation portion 81 has a first buffer unit 50 and a first voltage divider unit 91. The first buffer unit 50 has a plurality of offset compensation gamma buffers 51, 52, 53, and 54. Although a various number of offset compensation gamma buffers may be included, this embodiment will be described by assuming that four offset compensation gamma buffers 51, 52, 53, and 54 are included. The lower gray scale voltage generation portion 82 has a second buffer unit 70 and a second voltage divider unit 92. Similarly, although a various number of offset compensation gamma buffers may be included, it is assumed that four offset compensation gamma buffers 55, 56, 57, and 58 are used in the second buffer unit 70.

Each of the first to fourth offset compensation gamma buffers 51, 52, 53, and 54 has: a buffer 71, 72, 73, and 74 which outputs a corresponding input voltage IN1, IN2, IN3, and IN4 input to a positive or negative input terminal as a corresponding output voltage OUT1, OUT2, OUT3, and OUT4, respectively; and a switching unit 61, 62, 63, and 64 which selectively connects the input voltage IN1, IN2, IN3, and IN4 and the output voltage OUT1, OUT2, OUT3, and OUT4 of the buffer 71, 72, 73, and 74 to the positive and negative input terminals of the buffer 71, 72, 73, and 74, respectively, in response to the control signal CTRL. Similarly, each of fifth to eighth offset compensation gamma buffers 55, 56, 57, and 58 has: a buffer 75, 76, 77, and 78 which outputs a corresponding input voltage IN5, IN6, IN7, and IN8 input to the positive or negative input terminal as a corresponding output voltage OUT5, OUT6, OUT7, and OUT8, respectively; and a switching unit 65, 66, 67, and 68 which selectively connects the input voltage IN5, IN6, IN7, and IN8 and the output voltage OUT5, OUT6, OUT7, and OUT8 of the buffer 75, 76, 77, and 78 to the positive and negative input terminals, respectively, in response to the control signal CTRL.

The first voltage divider unit 91 includes a resistor string connected in series between the output voltages OUT1 and OUT4 of the first and fourth offset compensation gamma buffers 51 and 54. The output voltages OUT2 and OUT3 of the second and third offset compensation gamma buffers 52 and 53 are connected to middle nodes of the resistor string, and the voltage levels divided by the resistor string are generated as upper gray scale voltages VH gray0, . . . , VH gray<i>, . . . , VH gray<j>, . . . , and VH gray63. Similarly, the second voltage divider unit 92 includes a resistor string connected in series between the output voltages OUT5 and OUT8 of the fifth and eighth offset compensation gamma buffers 55 and 58. The output voltages OUT6 and OUT7 of the sixth and seventh offset compensation gamma buffers 56 and 57 are connected to middle nodes of the resistor string, and the voltage levels divided by the resistor string are generated as gray scale voltages VLgray0, . . . , VLgray<i>, . . . , VLgray<j>, . . . , and VLgray63.

The gray scale voltage generation circuit 80 alternately switches the input voltages IN1 to IN8 input to the positive and negative input terminals of the buffers 71 to 78 and the output voltages OUT1 to OUT8 of the buffers 71 to 78 in response to the control signal CTRL to generate offset-compensated output voltages OUT1 to OUT8. Accordingly, in both of the upper gray scale voltages VHgray0, . . . , VHgray<i>, . . . , VHgray<j>, . . . , and VHgray63 and the lower gray scale voltages VLgray0, . . . , VLgray<i>, . . . , VLgray<j>, . . . , and VLgray63 generated from the output voltages OUT1 to OUT8, the offset voltages have been compensated. As a result, the upper gray scale voltages VHgray0, VHgray<i>, VHgray<j>, and VHgray63 and the lower gray scale voltages (VLgray0, VLgray<i>, VLgray<j>, and VLgray63 directly connected to the output voltages OUT1 to OUT8 of the offset compensation gamma buffers 51 to 58 can have a stable voltage level.

On the other hand, an option for disabling the offset compensation gamma buffers 51 to 58 can be added as shown in Table 1 in order to facilitate offset measurement of a digital-analog conversion circuit for converting digital RGB data stored in the data latch unit of the source driver into analog RGB data.

TABLE 1
ENABLE & DISABLE OPTIONS FOR OFFSET COMPENSATON
GAMMA BUFFERS

| | |
|---|---|
| TYPES | DISABLE ALL OFFSET COMPENSATION GAMMA |
| | BUFFERS 51 TO 58 |
| | ENABLE 1st, 4th, 5th, and 8th OFFSET COMPENSATION |
| | GAMMA BUFFERS 51, 54, 55, AND 58 |
| | ENABLE 1st, 2th, 4th, 5th, 7th, and 8th OFFSET |
| | COMPENSATION GAMMA BUFFERS 51, 52, 54, 55, 57, |
| | AND 58 |
| | ENABLE ALL OFFSET COMPENSATION GAMMA |
| | BUFFERS 51 TO 58 |

Operation for enabling or disabling the offset compensation gamma buffers 51 to 58 is accomplished by controlling the first to fourth buffers 71 to 74 and fifth to eighth buffers 75 to 78 based on a combination of first and second option signals OP [1:0]. For example, when all of the output terminals of offset compensation gamma buffers 51 to 57 are disabled, voltages may be directly applied to the voltage dividers 91 and 92 to exclude the offset of the offset compensation gamma buffers 51 to 58 and measure the offset of the digital-analog conversion circuit.

While the present invention has been particularly shown and described with reference to exemplary embodiments thereof, it will be understood by those skilled in the art that various changes in form and details may be made therein without departing from the spirit and scope of the present invention as defined by the appended claims.

1-10. (canceled)

11. A gray scale voltage generation circuit comprising:
a buffer unit which receives first and second input voltages and outputs first and second output voltages; and
a gray scale voltage generation unit which includes a resistor string formed at inside of the same integrate circuit with a source driver integrate circuit with the buffer unit, directly connected to the output terminal of the buffer unit and applied by the first and second output voltages and generates gray scale voltages divided by the resistor string,
wherein the buffer unit has:
a first buffer which outputs the first input voltage input to a first positive input terminal or a first negative input terminal as the first output voltage;
a second buffer which outputs the second input voltage input to a second positive input terminal or a second negative input terminal as the second output voltage;
a first switching unit which selectively connects the first input voltage and the first output voltage of the first buffer to the first positive input terminal and the first negative input terminal in response to a control signal; and
a second switching unit which selectively connects the second input voltage and the second output voltage of the second buffer to the second positive input terminal and the second negative input terminal in response to the control signal.

12. The gray scale voltage generation circuit according to claim 11, further comprising a third buffer unit which generates at least one third output voltage having a voltage level between the first and second output voltages, and directly connects the third output voltage to at least one connecting node arranged in the resistor string,
wherein the third buffer unit has:
a third buffer which outputs a third input voltage input to a third positive input terminal or a third negative input terminal as the third output voltage; and
a third switching unit which selectively connects the third input voltage and the third output voltage of the third buffer to the third positive input terminal and the third negative input terminal in response to the control signal.

13. The gray scale voltage generation circuit according to claim 11, wherein the buffer unit selectively disables the first or second buffer in response to an option signal.

14. The gray scale voltage generation circuit according to claim 11, wherein the control signal is periodically inverted in the unit of one horizontal line and two frames of an image displayed in a liquid crystal panel.

15. The gray scale voltage generation circuit according to claim 11, wherein the control signal is periodically inverted in the unit of one horizontal line and four frames of an image displayed in a liquid crystal panel.

16. The gray scale voltage generation circuit according to claim 11, wherein the control signal is periodically inverted in the unit of two horizontal lines and two frames of an image displayed in a liquid crystal panel.

17. The gray scale voltage generation circuit according to claim 11, wherein the control signal is periodically inverted in the unit of two horizontal lines and four frames of an image displayed in a liquid crystal panel.

18. The gray scale voltage generation circuit according to claim 11, wherein the control signal is periodically inverted in the unit of four horizontal lines and two frames of an image displayed in a liquid crystal panel.

19. The gray scale voltage generation circuit according to claim 11, wherein the control signal is periodically inverted in the unit of four horizontal lines and four frames of an image displayed in a liquid crystal panel.

20. The gray scale voltage generation circuit according to claim 11, wherein the control signal is periodically inverted in the unit of two frames of an image displayed in a liquid crystal panel.

21. The gray scale voltage generation circuit according to claim 11, wherein the control signal is periodically inverted in the unit of four frames of an image displayed in a liquid crystal panel.
